(19) United States
(12) Patent Application Publication
(10) Pub. No.: US 2022/0355673 A1
(43) Pub. Date: Nov. 10, 2022

(54) VEHICULAR WIND TURBINE SYSTEM

(71) Applicant: Pradeep Kumar Balakrishnan, San Ramon, CA (US)

(72) Inventor: Pradeep Kumar Balakrishnan, San Ramon, CA (US)

(21) Appl. No.: 17/715,474

(22) Filed: Apr. 7, 2022

Related U.S. Application Data
(60) Provisional application No. 63/184,215, filed on May 5, 2021.

(51) Int. Cl. B60L 8/00; F03D 9/25; F03D 9/32

(52) U.S. Cl. CPC B60L 8/006; F03D 9/25; F03D 9/32; F05B 2240/941; F05B 2270/321; F05B 2270/32

(57) ABSTRACT

A vehicular wind turbine system includes a vehicle having a propulsion system. The vehicular wind turbine system further includes a first wind turbine attached to the vehicle. The first wind turbine includes a plurality of turbine blades coupled to an electric generator. The first wind turbine is configured to convert energy from a relative wind into electrical energy via the electric generator. The system further includes a battery disposed within the vehicle to store electrical energy from the first wind turbine. The system further includes an electric motor configured to convert electrical energy stored in the battery into kinetic energy. The vehicle is to be propelled by at least the electric motor.

### RELATED APPLICATIONS

This application claims the benefit of U.S. Provisional Application No. 63/184,215, filed May 5, 2021, the entire contents of which are incorporated herein by reference.

### TECHNICAL FIELD

Embodiments of the present disclosure relate to a wind turbine system, and in particular to a vehicular wind turbine system.

### BACKGROUND

Vehicles can be propelled by an electric motor. Such electric vehicles include an on-board battery. Wind turbines are commonly used to convert wind energy into electrical energy. Wind turbines are conventionally mounted to the ground (i.e., are stationary).

### BRIEF DESCRIPTION OF THE DRAWINGS

The examples described herein will be understood more fully from the detailed description given below and from the accompanying drawings, which, however, should not be taken to limit the application to the specific examples, but are for explanation and understanding only.

FIG. 1A is a simplified diagram illustrating a top view of a cross section of a vehicular wind turbine system, according to certain embodiments.

FIG. 1B is a simplified diagram illustrating a side view of a cross section of a vehicular wind turbine system, according to certain embodiments.

FIG. 1C is a simplified diagram illustrating a top view of a cross section of the vehicular wind turbine system of FIG. 1A, according to certain embodiments.

FIG. 2A is a simplified diagram illustrating a top view of a cross section of a turbine for a vehicular wind turbine system, according to certain embodiments.

FIG. 2B is a simplified diagram illustrating a side view of a cross section of a turbine of a vehicular wind turbine system, according to certain embodiments.

FIG. 3 is a simplified diagram illustrating a top view of a cross section of a vehicular wind turbine system, according to certain embodiments.

FIG. 4 is a flow chart illustrating a method for operating a vehicular wind turbine system, according to certain embodiments.

### DETAILED DESCRIPTION

Embodiments described herein are related to a vehicular wind turbine system.

Electric vehicles are propelled by an electric motor mechanically connected to its propulsion means (e.g., wheels, and/or propeller, etc.). The electric motor converts electrical energy into mechanical energy. An electric vehicle stores its electrical energy in an on-board battery. The on-board battery must be recharged regularly. The amount of electrical energy the battery can hold often determines the electric vehicle's operating range. To increase an electric vehicle's operating range, a battery that stores more electrical energy can be used. Commonly, larger batteries storing more electrical energy can be used to extend an electric vehicle's operating range. However, larger batteries can lessen the overall efficiency of the electric vehicle because larger batteries are often heavier, requiring more electrical energy be used by the motor to propel the vehicle. Additionally, larger batteries can take longer to charge, frustrating an operator (e.g., a driver) of an electric vehicle who must wait longer periods for the battery to be charged. Stopping to recharge the batteries also interrupts continuous travel. Additionally, larger batteries are more expensive and consume more resources than smaller batteries. Further, charging electric vehicles often requires a special charging device, which are often located at inconvenient locations and are fewer in number compared to fuel pumps (e.g., gas stations, filling stations, etc.), complicating the operator's route. Additionally, charging an electric vehicle can be costly.

Some electric vehicles are provided with a second power source. A hybrid vehicle typically includes an internal-combustion engine and an electric motor to propel the vehicle. Hybrid vehicles also include a battery to store electrical energy. Conventionally, a hybrid vehicle is propelled by its engine when its electric motor cannot supply the required power. For instance, a hybrid vehicle may be powered by its electric motor at slow speeds, or at a steady state speed. A hybrid vehicle's engine may activate under hard acceleration or when the electric motor alone cannot maintain the speed of the vehicle. Often times, the electric motor behaves as an electric generator when the engine is activated. Generating electricity may cause the battery to be charged. Although a hybrid vehicle may emit fewer carbon emissions than a traditional internal-combustion vehicle, a hybrid vehicle having an internal combustion engine will still emit carbon emissions. Traditional hybrid vehicles must regularly be filled with fuel (e.g., gasoline, diesel, etc.) so that the engine can run, requiring the operator to plan stops along his or her planned route.

Wind turbines coupled to electric generators are commonly used to convert energy from a blowing wind into electrical energy. Conventionally, wind turbines are installed as permanent, immovable structures. Commonly, multiple wind turbines are installed in areas that are regularly windy (e.g., at the mouth of a canyon, near a beach, etc.). Multiple wind turbines (e.g., a wind farm) may best capture energy from the blowing wind. Typically, wind turbines provide electricity to the power grid (e.g., the electrical power grid that provides electricity to homes, stores, offices, etc.). Wind turbines can be activated or deactivated (i.e., turned on and/or shut off) as energy needs increase or decrease. For example, as energy needs increase (such as on a hot afternoon when many homeowners turn on their home's air-conditioning units), more wind turbines may be activated.

The devices, systems, and methods disclosed herein provide a vehicular wind turbine system that extends the range of an electric-powered and/or hybrid vehicle. In some embodiments, the vehicular wind turbine system may include a vehicle chassis (e.g., for a car, a truck, a train, an airplane, a boat, a ship, etc.) having a propulsion system. The propulsion system may include an engine (e.g., an internal combustion engine) and/or an electric motor. In some embodiments, one or more wind turbines are attached to and/or integrated into the vehicle chassis. The wind turbine(s) may include multiple turbine blades attached to a central hub. The wind turbine(s) may be mechanically coupled to an electric generator. The wind turbine(s) may convert energy from a relative wind (e.g., wind passing by the vehicle as the vehicle is moving and/or stopped) into electrical energy via the generator. In some embodiments, the vehicular wind turbine system includes a battery within the vehicle. The battery may store electrical energy generated by the generator coupled to the wind turbine. In some embodiments, an electric motor converts the electrical energy stored in the battery into kinetic energy to propel the vehicle. In some embodiments, the wind turbine system may be deactivated under certain driving conditions and may be activated under certain other driving conditions. For example, the wind turbine system may be activated while the vehicle is braking, stopped, or coasting downhill and may be deactivated while the vehicle is being propelled forward by its engine and/or electric motor.

The devices, systems, and methods disclosed herein have advantages over conventional systems. The vehicular wind turbine system disclosed herein may provide a longer range for an electric and/or hybrid vehicle when compared to conventional systems. The extended range provided by the vehicular wind turbine system disclosed herein allows the operator (e.g., the driver) more flexibility in route planning by not requiring the operator to stop and charge the vehicle and/or fill the vehicle with fuel at such regular intervals as conventional systems require. Additionally, the operator of the vehicular wind turbine system disclosed herein need not wait long periods for the system to charge, as is necessary with conventional electric vehicles. The vehicular wind turbine system of the present disclosure may also emit fewer carbon emissions when compared to traditional hybrid vehicles by utilizing the wind turbine and electric generator to charge the battery, instead of relying solely on an internal-combustion engine or other methods (e.g., regenerative braking, etc.) to charge the battery. Additionally, the vehicular wind turbine system of the present disclosure may allow for the use of a smaller battery when compared to a similar all-electric vehicle because the battery can be recharged by the onboard generator coupled to the wind turbine. A smaller battery may be lighter and may allow the vehicular wind turbine system disclosed herein to be more efficient overall when compared to traditional electric vehicles.

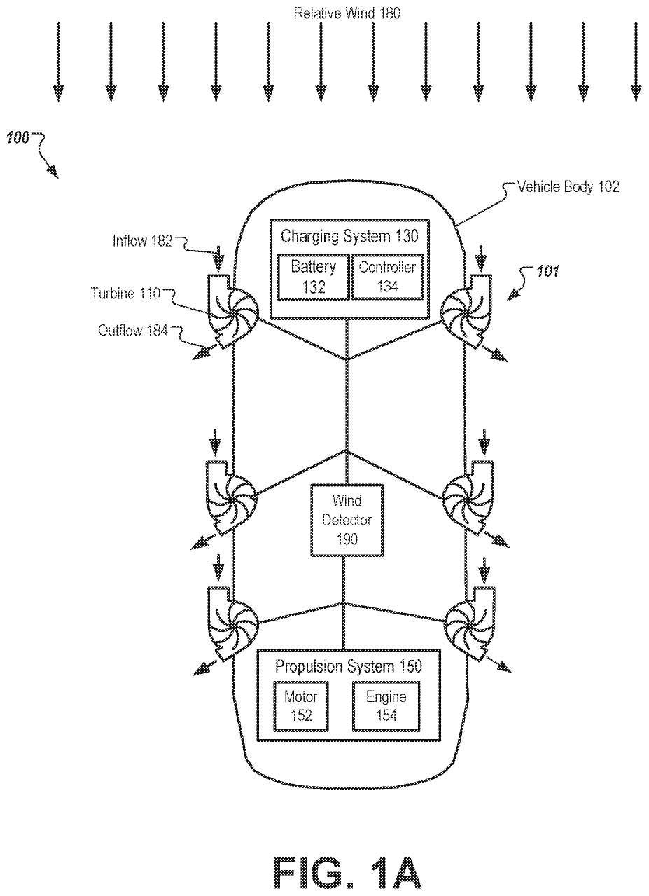

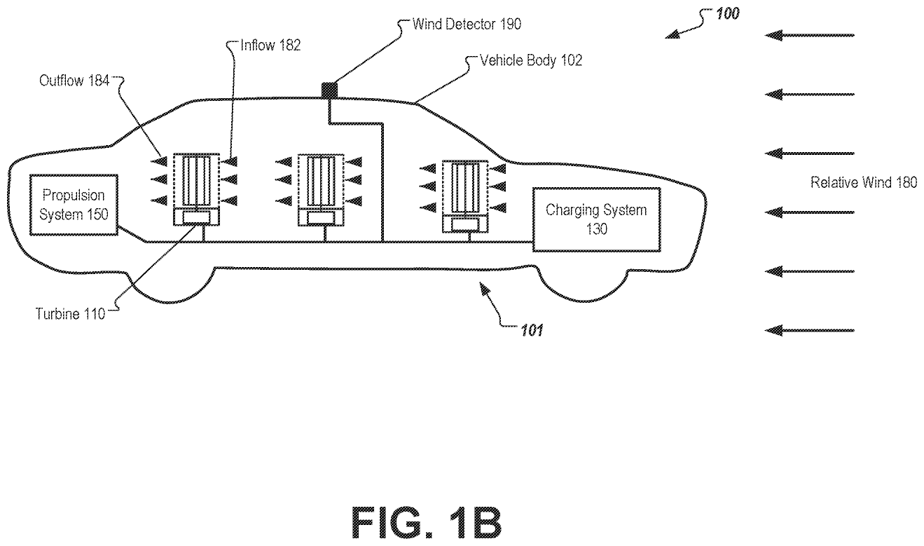

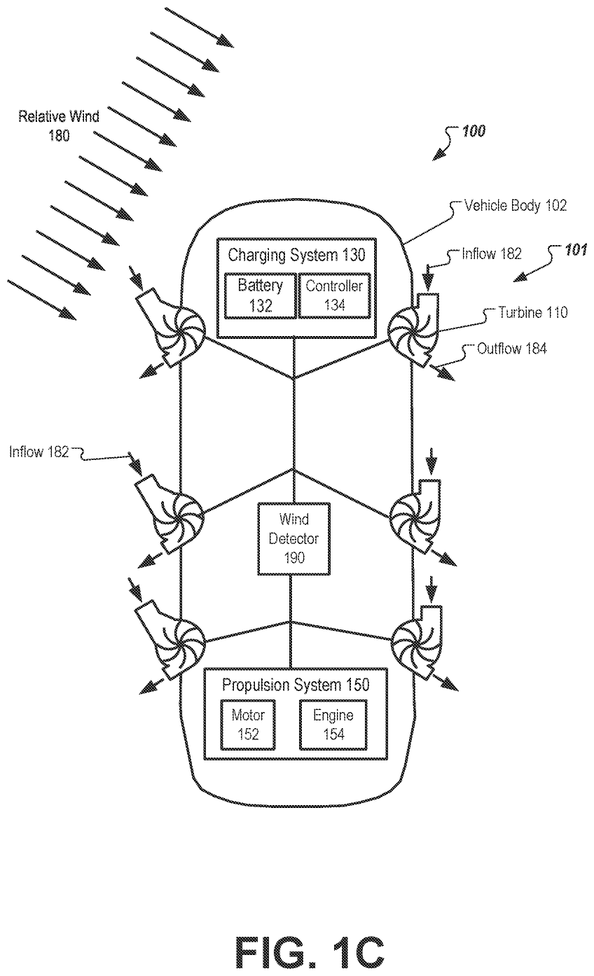

FIG. 1A is a simplified diagram illustrating a top view of a cross section of a vehicle 100 that includes a vehicular wind turbine system 101, according to certain embodiments. FIG. 1B is a simplified diagram illustrating a side view of a cross section of the vehicular wind turbine system 101, according to certain embodiments. In some embodiments, features that have reference numbers that are similar to reference numbers in other figures include similar features and/or functionality as those described in other figures. The simplified diagrams omit many common features of vehicles for simplicity and to better show the vehicular wind turbine system 101. It should be understood that the vehicle 100 would include standard vehicle components such as, for example, wheels, windows, mirrors, axles, steering wheel, seats, and so on.

In some embodiments, vehicle 100 includes a vehicle body 102 (e.g., vehicle chassis) within which the vehicular wind turbine system 101 is integrated. Vehicle body 102 is illustrated in FIGS. 1A and 1B as a typical four-door sedan (e.g., a car). However, a person of ordinary skill in the art should recognize that vehicle body 102 may be that of a car, a truck, a sport-utility vehicle (SUV), a bicycle, a motor-bike (e.g., a motorcycle), a train, an airplane, a boat, and/or a ship, etc. Vehicle body 102 may house a propulsion system (e.g., propulsion system 150), driver and passenger seats, driver controls, suspension, interior climate control, a fuel tank, and/or vehicle safety features (e.g., mirrors, restraints, etc.).

Vehicle 100 may include a propulsion system 150. In some embodiments, propulsion system 150 includes a motor 152, and/or an engine 154. In some embodiments, propulsion system 150 includes multiple motors 152. Motor 152 may be an electric motor. Engine 154 may be an internal combustion engine (e.g., a gasoline-powered engine, a diesel-powered engine, etc.). In some embodiments, engine 154 is a hydrogen-powered engine. Motor 152 and/or engine 154 may be coupled to a transmission. In some embodiments, motor 152 and/or engine 154 are coupled to wheels of the vehicle via a transmission and/or a gear drive (e.g., a differential). In some embodiments, motor 152 and/or engine 154 may be coupled to a propeller of the vehicle (e.g., a propeller of an airplane, a propeller of a boat or ship, etc.) via a gear drive or another drive mechanism for direct electric drive (e.g., a drive shaft, an axle shaft, a CV shaft, etc.). Motor 152 may be configured to convert electrical energy stored in a battery (e.g., battery 132) into kinetic energy to propel the vehicle. As illustrated in FIGS. 1A and 1B, propulsion system may be disposed within vehicle body 102 near a rear of vehicle body 102. In some embodiments, propulsion system 150 may be disposed near a front of vehicle body 102. In some embodiments, propulsion system 150 may be disposed along a length of vehicle body 102 (e.g., front-engine-rear-wheel-drive). In some embodiments, propulsion system 150 may be disposed substantially near both a front and rear of vehicle body 102 (e.g., having a first motor 152 near the front to power the front wheels and having a second motor 152 near the rear to power the rear wheels).

As the vehicle moves, a relative wind 180 may be experienced by the vehicle. Relative wind 180 may be a movement of the atmosphere (e.g., the air) relative to vehicle body 102. Relative wind 180 may have direction and magnitude. Relative wind 180 may be a function of movement of the vehicle 100 as well as the movement of wind (e.g., movement of air relative to vehicle 100). Accordingly, the vehicle 100 may experience relative wind 180 while stationary (e.g., the wind blows while the vehicle is parked) as well as while moving. For example, the vehicle may experience a relative wind 180 while stationary at a stoplight when the wind blows, or while parked in a windy area, or while accelerating or driving.

In some embodiments, vehicular wind turbine system 101 may include a wind detector 190. Wind detector 190 may sense relative wind 180. Wind detector 190 may detect one or more properties of relative wind 180. Wind detector 190 may sense a direction and/or a magnitude of relative wind 180. In some embodiments, wind detector 190 may include a wind speed detector. In some embodiments, wind detector 190 may include a wind direction detector (e.g., a weather vane). In some embodiments, wind detector 190 is a combination wind-speed and wind-direction sensor. Wind detector 190 may provide sensor data indicative of relative wind 180. In some embodiments, wind detector 190 is mounted on an exterior surface of vehicle body 102. In certain embodiments, wind detector 190 is mounted on a top surface of vehicle body 102.

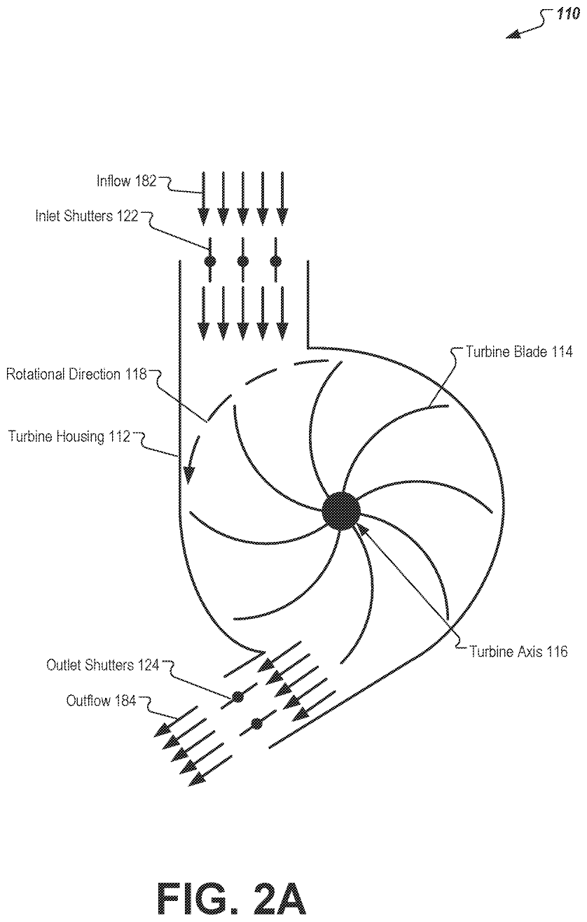

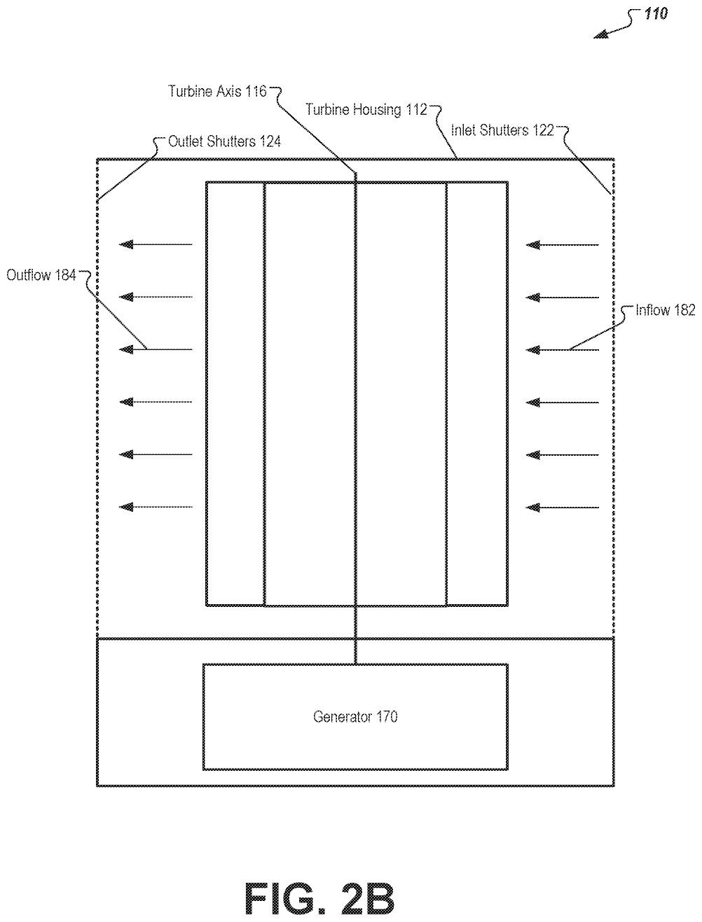

Vehicular wind turbine system 101 includes a turbine 110 electrically connected to a charging system 130 via a generator (e.g., generator 170 of FIG. 2B). In some embodiments, vehicular wind turbine system 101 includes one or more additional wind turbines (e.g., a plurality of turbines 110). As illustrated in FIG. 1A, vehicular wind turbine system 101 may include six turbines 110, however, in some embodiments, vehicular wind turbine system 101 may include more than six turbines 110 or fewer than six turbines (e.g., one to four turbines on a left side of the vehicle 100 and one to four turbines on a right side of the vehicle 100). Turbine(s) 110 may include an electric generator (e.g., generator 170 of FIG. 2B). Turbine(s) 110 may receive an inflow 182 of air. Inflow 182 may be a portion of relative wind 180 that is received by an inlet of a turbine 110. Turbine(s) 110 may each include multiple turbine blades (e.g., turbine blades 114 of FIG. 2A). The turbine blades may have a fixed geometry. Alternatively, the turbine blades may have a variable geometry (e.g., the geometry of the turbine blades (e.g., pitch, angle-of-attack, etc.) can be changed based on inflow 182 and/or relative wind direction). The geometry of the turbine blades may be altered to optimize an efficiency of turbine(s) 110. In some embodiments, the geometry of the turbine blades is changed based on sensor data from a wind detector 190. Turbine(s) 110 may harness kinetic energy from inflow 182, and in turn the electric generator(s). Turbine(s) 110 may exhaust outflow 184 after harnessing kinetic energy from the flow of air.

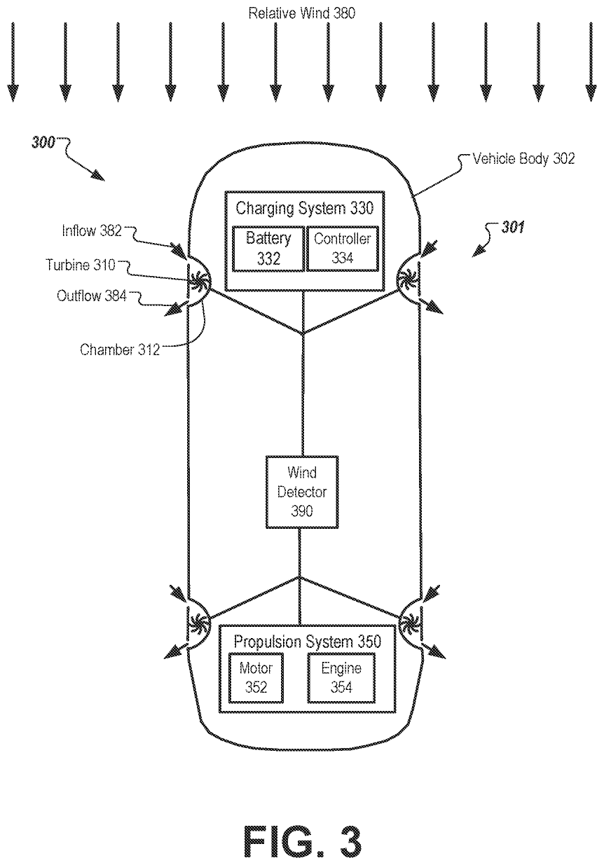

In some embodiments, turbine(s) 110 are mounted to a side of vehicle body 102. In some embodiments, turbine(s) 110 are mounted on an inside of vehicle body 102. In some embodiments, one or more turbines 110 are mounted in or on a top of the vehicle body 102 in a substantially aerodynamic arrangement and/or in or near a bottom of the vehicle body. In some embodiments, a turbine housing houses two or more turbines. In some embodiments, the two are more turbines are counter-rotating turbines (e.g., a first turbine turns a first direction and a second turbine turns a second direction opposite of the first direction). In some embodiments, one or more turbines 110 are mounted in or on a surface of the vehicle body 102 that is at an angle between 0 degrees and 90 degrees to a longitudinal axis of the vehicle body 102. In some embodiments, a chamber disposed within vehicle body 102 houses each turbine 110. The turbine(s) 110 may be enclosed within the chamber(s). The chamber(s) may house turbine(s) 110 so that turbine(s) 110 do not project outside vehicle body 102 in some embodiments, as shown in FIG. 3.

In some embodiments, turbine(s) 110 include an inlet channel and an outlet channel. In some embodiments, turbine(s) 110 are mounted integral to vehicle body 102. In some embodiments, a housing of turbine(s) 110 is constructed to be aerodynamically efficient (e.g., is formed so as not to create unnecessary drag). In some embodiments, a housing of turbine(s) 110 has a low profile exterior to vehicle body 102 (e.g., the housing does not project unnecessarily far from a surface of vehicle body 102), as shown in FIG. 3. In some embodiments, turbine(s) 110 are mounted on a top surface of vehicle body 102. In some embodiments, turbine(s) 110 and/or the housing of turbine(s) 110 are mounted to the vehicle body 102 using spring mounts to cushion an impact of incoming air and/or other objects (road debris, etc.).

Electrical energy generated by turbine(s) 110 may be transferred from the electric generator of the turbines to charging system 130 via an electrical connection and stored in a battery 132 of charging system 130.

Charging system 130 may include circuitry and/or software to control the charging and/or discharge of battery 132. Charging system 130 may include a controller 134. Controller 134 may receive sensor data (e.g., from wind detector 190), and/or operator inputs (e.g., driver commands). In some embodiments, controller 134 may cause activation of turbine(s) 110 based on sensor data received and/or one or more operator inputs. In some embodiments, battery 132 is contained within vehicle body 102. Battery 132 may be used to power motor 152. In some embodiments, after battery 132 is charged, battery 132 can be removed from vehicle body 102 to power a device unrelated to vehicular wind turbine system 101. For example, battery 132 may be removed from vehicle 100 and used to power an external appliance. In some embodiments, battery 132 may be used to wirelessly charge (e.g., via a wireless charging system) an external appliance and/or an electric power network (e.g., an external power grid, etc.). In some embodiments, battery 132 may be used to power one or more vehicle sub-systems (e.g., a climate control system, a lighting system, etc.). In some embodiments, battery 132 is a lithium-ion battery. In some embodiments, battery 132 is a lead-acid battery. In many embodiments, battery 132 is a rechargeable battery.

In FIGS. 1A and 1B, charging system 130 is illustrated as being disposed near a front of vehicle body 102. However, in some embodiments, charging system 130 may be disposed near a center of vehicle body 102. In some embodiments, charging system 130 may be disposed near a rear of vehicle body 102. In some embodiments, at least a portion of charging system 130 (e.g., battery 132) may be located substantially under a floor of a passenger compartment of vehicle body 102. In some embodiments, components of charging system 130 may be disposed within vehicle body 102 to maximize efficient use of space.

In some embodiments, one or more turbines 110 are activated at certain times or under certain conditions. Controller 134 may cause turbine(s) 110 to be activated when certain criteria are satisfied. For example, turbine(s) 110 may activate (e.g., convert wind energy to electrical energy) responsive to a vehicle operator command. The operator command may be a vehicle braking command (e.g., the operator activates brakes of the vehicle), a vehicle coasting command (e.g., the operator lets off the throttle (e.g., gas pedal, throttle lever, etc.)), or a vehicle parking command (e.g., the operator parks the vehicle). For example, as the vehicle travels down a hill, the driver may apply the brakes. The controller 134 receives sensor data indicating that the brakes have been applied and then may cause turbine(s) 110 to be activated. In another example, the driver may park the vehicle. The controller 134 receives sensor data indicating that the vehicle has been parked (e.g., sensor data indicating that the wheels are not spinning) and then may cause turbine(s) 110 to be activated. In a further example, as the driver lifts a foot from the “gas pedal” (e.g., closes the throttle, causes the power to the motor and/or engine to be stopped, etc.), the vehicle may begin to coast. The controller 134 may receive sensor data indicating the vehicle is beginning to coast and then cause turbine(s) 110 to be activated.

In some embodiments, vehicular wind turbine system 101 includes wind detector 190. Wind detector 190 may sense relative wind 180. Wind detector 190 may detect one or more properties of relative wind 180. Wind detector 190 may sense a direction and/or a magnitude of relative wind 180. In some embodiments, wind detector 190 includes a wind speed detector. In some embodiments, wind detector 190 includes a wind direction detector (e.g., a weather vane). In some embodiments, wind detector 190 is a combination wind-speed and wind-direction sensor. Wind detector 190 may provide sensor data indicative of relative wind 180. In some embodiments, wind detector 190 is mounted on an exterior surface of vehicle body 102. In certain embodiments, wind detector 190 is mounted on a top surface of vehicle body 102.

In some embodiments, turbine(s) 110 are activated based on sensor data received from wind detector 190. For example, turbines 110 on a left of the vehicle may be activated (e.g., automatically or otherwise) when wind is detected to have a directional component that is from left to right (e.g., see FIG. 1C) and turbines 110 on a right of the vehicle may be activated when wind is detected to have a directional component that is from right to left relative to the front of the vehicle. In some embodiments, turbine(s) 110 activate after the vehicle reaches a predetermined speed. Engine 154 may power the vehicle until the vehicle reaches the predetermined speed. Once the vehicle reaches the predetermined speed, turbine 110 may activate. At the predetermined speed, the vehicle may transition from being propelled by engine 154 to being propelled by motor 152. For example, engine 154 may cause the vehicle to accelerate to a predetermined speed, at which point turbine 110 is activated. Further, engine 154 may be turned off and the vehicle may then be propelled by motor 152. The activated turbine(s) 110 may generate electricity to charge battery 132 as motor 152 draws electrical energy from battery 132. In some embodiments, controller 134 causes turbine(s) 110 to activate responsive to sensor data received from wind detector 190 indicating that relative wind 180 has a magnitude equal to or greater than a predetermined value. In some embodiments, controller 134 regulates charging of battery 132. In some embodiments, controller 134 may cause one or more turbines 110 to be activated. In some embodiments, controller 134 may cause less than a total number of turbines 110 included in the vehicular wind turbine system 101 to be activated. In some embodiments, controller 134 regulates the charging and/or discharge of battery 132 based on conditions of battery 132 (e.g., temperature, charge, age, etc.).

In some embodiments, turbine(s) 110 generate electricity while the vehicle is slowing down. For example, when the vehicle's brakes are applied, controller 134 may cause turbine 110 to activate and generate electricity to charge battery 132. The turbines 110 may assist in slowing down the vehicle by increasing an air resistance, and may at the same time generate electricity. In another example, when the vehicle is coasting (e.g., moving while energy is not being expended by either engine 154 or motor 152 to propel the vehicle), controller 134 may cause turbine(s) 110 to activate and generate electricity to charge battery 132. In some embodiments, activating turbine(s) 110 includes controller 134 causing one or more shutters of a turbine inlet (e.g., inlet shutters 122 of FIGS. 2A and 2B) to be opened to allow inflow 182 to flow into the turbine housing. In some embodiments, while turbines 110 are deactivated and inlet shutters 122 are closed, the inlet shutters 122 are flush or substantially flush with a surface of the vehicle body 102, thus reducing drag. In some embodiments, activating a turbine 110 includes controller 134 causing one or more shutters of a turbine outlet (e.g., outlet shutters 124 of FIGS. 2A and 2B) to open to allow outflow 184 to flow out of the turbine housing. Controller 134 may cause shutters of turbine 110 to close while turbine 110 is not activated to reduce drag on the vehicle.

In some embodiments, the inlet of turbine(s) 110 has a variable geometry. The inlet of turbine(s) 110 may be a variable inlet. The inlet of turbine(s) 110 may adjust (e.g., based on a command from controller 134) to receive inflow 182. The adjustment may be based on one or more properties of relative wind 180. For example, responsive to a command from controller 134, a geometry of the turbine inlet and/or direction of an opening of a shutter associated with the turbine inlet may change based on sensor data received from wind detector 190.

FIG. 1C illustrates a simplified top view of a cross section of the vehicular wind turbine system 101, according to certain embodiments. In some embodiments, vehicle 100 experiences a relative wind 180 primarily from a side (e.g., from a left side of vehicle 100, as illustrated in FIG. 1C). The relative wind 180 may be primarily from a side when vehicle 100 travels at low speeds relative to the speed of a blowing wind. Similarly, the relative wind 180 may be primarily from a side when the speed of a crosswind exceeds the speed at which vehicle 100 is traveling (e.g., forward or reverse). In instances where the relative wind 180 is primarily from a side, a magnitude of inflow 182 may be reduced. In some instances, the magnitude of inflow 182 into a turbine 110 on a leeward side of vehicle 100 (e.g., on the right side as illustrated in FIG. 1C) may be reduced completely (i.e., reduced to zero if the relative wind is blowing primarily from the left side). In some embodiments, where the relative wind 180 is primarily from one side of vehicle 100 (e.g., primarily blowing from left to right as shown), windward turbine(s) 110 (e.g., turbines 110 on the left side of vehicle 100 as illustrated in FIG. 1C) may be activated, while leeward turbine(s) 110 (e.g., turbine(s) 110 on the right side of vehicle 100 as illustrated in FIG. 1C) may be deactivated.

In some embodiments, the inlet of turbine(s) 110 may adjust based on the direction of the relative wind 180. In some embodiments, the inlet of windward turbine(s) 110 adjust based on the direction of the relative wind 180. For example, responsive to a command from controller 134 based on sensor data from wind detector 190 indicating that the relative wind 180 is primarily from a left side of vehicle 100, an inlet of turbine(s) 110 on the left side of vehicle 100 may adjust to the left to receive a portion of relative wind 180 (e.g., inflow 182). The inlet of windward turbine(s) 110 may be adjusted by an actuator (e.g., an electronic actuator, a pneumatic actuator, a hydraulic actuator, etc.). In some embodiments, the inlet of turbine(s) 110 turns into the relative wind 180 (e.g., turns the direction from which relative wind 180 is coming). The inlet of turbine(s) 110 turning toward the relative wind 180 may increase a magnitude of inflow 182, which may increase electrical output from turbine(s) 110.

FIG. 2A is a simplified diagram illustrating a top view of a cross section of a turbine 110 of a vehicular wind turbine system, according to certain embodiments. FIG. 2B is a simplified diagram illustrating a side view of a cross section of a turbine 110 of a vehicular wind turbine system, according to certain embodiments. In some embodiments, features that have reference numbers that are similar to reference numbers in other figures include similar features and/or functionality as those described in other figures.

In some embodiments, turbine 110 may include turbine housing 112 to house components of turbine 110. Multiple turbine blades 114 may be disposed within turbine housing 112. Turbine blades 114 may be connected to turbine axis 116. Turbine axis 116 may be a hub of turbine 110. Turbine blades 114 may rotate about a center of turbine axis 116 while turbine 110 is activated. In some embodiments, turbine blades 114 and turbine axis 116 rotate in a direction indicated by rotational direction 118 while turbine 110 is activated. In some embodiments, turbine 110 utilizes contra-rotating turbine blades (e.g., a first blade or first blade set rotates a first direction and a second blade or a second blade set rotates a direction opposite of the first direction). Contra-rotating turbine blades may increase the balance of the turbine 110 and may (in some embodiments) reduce drag. Turbine axis 116 may be mechanically coupled to generator 170. Generator 170 may generate electricity to charge a battery (e.g., battery 132 of FIGS. 1A and 1B) responsive to turbine blades 114 and turbine axis 116 spinning.

In some embodiments, turbine 110 is a vertical-axis wind turbine (e.g., a flow of air is perpendicular to the turbine axis). In some embodiments, turbine 110 is a horizontal-axis wind turbine (e.g., a flow of air is parallel to the turbine axis). In some embodiments, turbine blades 114 are vertical axis Savonius wind turbine blades. Using Savonius wind turbine blades may allow for turbine housing 112 to be mounted to a vehicle such that turbine housing 112 does not project unnecessarily far from a surface of the vehicle's body (e.g., vehicle body 102 of FIGS. 1A and 1B) and/or does not project outside of a surface of a vehicle's body.

In some embodiments, an inlet of turbine 110 receives air inflow 182. The inlet of turbine 110 may form an inlet channel. Inflow 182 may flow through an inlet flow path to turbine blades 114. The inlet flow path may direct incoming air to turbine blades 114. In some embodiments, one or more inlet shutters 122 regulate inflow 182. Inlet shutters may be controlled by a controller (e.g., controller 134 of FIG. 1A). Inlet shutters 122 may open and allow inflow 182 to flow into turbine housing 112 responsive to turbine 110 being activated by the controller. Opening inlet shutters 122 may expose turbine blades 114 to the relative wind. In some embodiments, inlet shutters 122 are actuated (e.g., opened and closed) by an electronic actuator, a hydraulic actuator, or a pneumatic actuator. In some embodiments, inlet shutters 122 are actuated by a servo motor. The actuator may open and/or close inlet shutters 122 based on a command from the controller. In some embodiments, the controller causes a size of an opening of the turbine inlet, a direction of inlet shutters and/or an orientation of an opening of the turbine inlet to adjust based on properties of the relative wind.

In some embodiments, an outlet of turbine 110 may exhaust outgoing air from turbine housing 112. The outlet of turbine 110 may exhaust outflow 184. In some embodiments, the outlet of turbine 110 forms an outlet channel to direct air outflow 184 along an outlet flow path. The outlet flow path may direct outgoing air from turbine 114. In some embodiments, an outlet of turbine 110 includes one or more outlet shutters 124. The outlet shutters 124 may regulate outgoing air from turbine housing 112. In some embodiments, outlet shutters 124 open responsive to turbine 110 being activated by the controller. In some embodiments, outlet shutters 124 are actuated by an electronic actuator or pneumatic actuator. In some embodiments, outlet shutters 124 are actuated by a servo motor. The actuator may open and/or close outlet shutters 124 based on a command from the controller.

FIG. 3 illustrates a simplified diagram of a top view of a cross section of a vehicular wind turbine system, according to certain embodiments. In some embodiments, features that have reference numbers that are similar to reference numbers in other figures include similar features and/or functionality as those described in other figures. In some examples, vehicular wind turbine system 301 has similar features and/or functionality as vehicular wind turbine system 101 of FIGS. 1A-C. In some embodiments, turbine(s) 310 are housed within chamber(s) 312 within the body of vehicle 300 (e.g., within vehicle body 302). Turbine(s) 310 may be housed such that turbine(s) 310 do not project outside vehicle body 302. Housing turbine(s) 310 in chamber(s) 312 within vehicle body 302 may reduce drag on vehicle body 302 as vehicle 300 travels (e.g., travels down a road, through the air, etc.).

In some embodiments, chamber(s) 312 include an inlet to receive incoming air from the relative wind (e.g., inflow 382). In some embodiments, inflow 382 is received by an intake which may protrude from vehicle body 302. In some embodiments, the inlet to chamber(s) 312 includes an inlet shutter. The inlet shutter may regulate a flow of incoming air. In some embodiments, a channel (e.g., a conduit, a flow channel, etc.) may guide inflow 382 from the inlet to turbine(s) 310.

In some embodiments, chamber(s) 312 include an outlet to exhaust an outflow from turbine(s) 310 (e.g., outflow 384). In some embodiments, the outlet of chamber(s) 312 includes an outlet shutter. The outlet shutter may regulate a flow of outgoing air. In some embodiments, the outlet of chamber(s) 312 may be substantially flush to a surface of vehicle body 302. Having a flush outlet may reduce drag on vehicle body 302. In some embodiments, a channel (e.g., a conduit, a flow channel, etc.) may guide outflow 384 from turbine(s) 310 to the outlet.

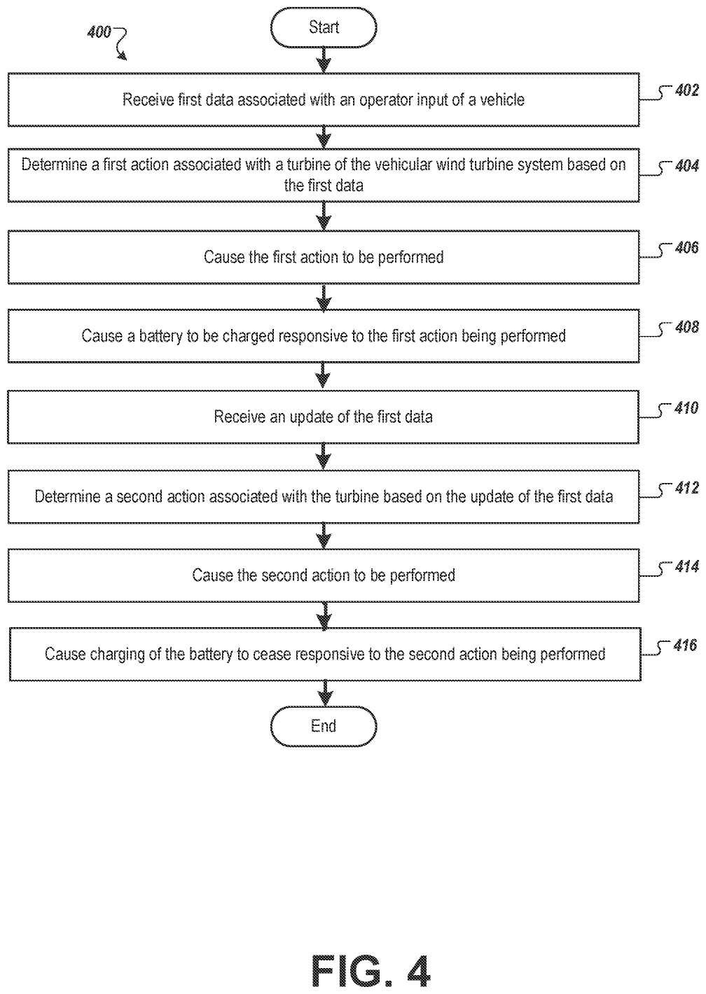

FIG. 4 illustrates a method 400 for operating a vehicular wind turbine system, according to certain embodiments. Method 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, a non-transitory storage medium stores instructions that when executed by a processing device (e.g., of controller 134, etc.) cause the processing device to perform method 400.

For simplicity of explanation, method 400 is depicted and described as a series of operations. However, operations in accordance with this disclosure can occur in various orders and/or concurrently and with other operations not presented and described herein. Furthermore, not all illustrated operations may be performed to implement method 400 in accordance with the disclosed subject matter. In addition, those skilled in the art will understand and appreciate that method 400 could alternatively be represented as a series of interrelated states via a state diagram or events.

Referring to FIG. 4, in some embodiments, at block 402, a processing device receives first data associated with an operator input of a vehicle. The first data may include a braking notification. The first data may include a velocity notification (e.g., a velocity of the vehicle), and/or an acceleration notification (e.g., an acceleration of the vehicle). The first data may include a notification (e.g., from wind detector 190 of FIGS. 1A-C) of sufficient wind to turn a turbine blade. In some embodiments, a processing device receives second data that indicates a relative wind. The processing device may receive the second data from a wind detection sensor (e.g., wind detector 190 of FIGS. 1A-C). In some embodiments, the second data includes wind speed data (e.g., wind speed magnitude), and/or wind direction data.

At block 404, in some embodiments, a processing device determines a first action associated with a turbine of the vehicular wind turbine system based on the first data. In some embodiments, the first action is determined based on the first data and/or the second data. Determining the first action may be responsive to receiving the first data. The first action may include activating a turbine. The first action may include turning the blades of a turbine. The first action may be an action associated with a turbine inlet and/or outlet (e.g., a turbine inlet adjustment action). For instance, the first action may include adjusting a turbine shutter. Specifically, the first action may be associated with a shutter of a turbine inlet (e.g., inlet shutters 122 of FIGS. 2A and 2B) and/or a shutter of a turbine outlet (e.g., outlet shutters 124 of FIGS. 2A and 2B). In some embodiments, the first action is a shutter opening action. In some embodiments, the first action may include adjusting a turbine blade (e.g., adjusting a geometry of a variable geometry turbine blade).

At block 406, in some embodiments, a processing device causes the first action to be performed. For example, a processing device may cause a turbine to be activated. As another example, a processing device may cause inlet shutters and/or outlet shutters of a turbine to be opened. In another example, a processing device may cause a turbine blade geometry to change (e.g., adjust). In a further example, a processing device may cause a turbine inlet direction to be adjusted to receive an inflow of air.

At block 408, in some embodiments, a processing device causes a battery to be charged responsive to the first action being performed. The battery may be a battery of a vehicular wind turbine system (e.g., battery 132 of FIGS. 1A-C, battery 332 of FIG. 3). For example, responsive to a turbine being activated, a processing device may cause electricity generated by the turbine be used to charge a battery.

At block 410, in some embodiments, a processing device receives an update of the first data. The update of the first data may include an update to a braking notification, an update to a velocity notification, and/or an update to an acceleration notification.

At block 412, in some embodiments, a processing device determines a second action based on the update of the first data, where the second action is associated with a turbine. Determining the second action may be responsive to receiving the update of the first data. The second action may be based on the update of the first data. The second action may include deactivating a turbine. The second action may be associated with a turbine inlet and/or outlet. For instance, the second action may include adjusting a turbine shutter. Specifically, the second action may be associated with a shutter of a turbine inlet and/or a shutter of a turbine outlet. In some embodiments, the second action is a shutter closing action. In some embodiments, the second action may include adjusting a turbine blade.

At block 414, in some embodiments, a processing device causes the second action to be performed. For example, a processing device may cause a turbine to be deactivated. As another example, a processing device may cause inlet shutters and/or outlet shutters of a turbine to be closed. In another example, a processing device may cause a turbine blade geometry to change. In a further example, a processing device may cause a turbine inlet direction to be adjusted.

At block 416, in some embodiments, a processing device causes charging of a battery (e.g., a battery of the vehicular wind turbine system) to cease responsive to the second action being performed. For example, electricity may not be generated by a turbine after the turbine has been deactivated. In some embodiments, excess power generated by a turbine may be dumped with dump load.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “inside,” “outside,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A vehicular wind turbine system comprising:
a vehicle having a propulsion system;
a first wind turbine attached to the vehicle, the first wind turbine comprising one or more turbine blades coupled to an electric generator;
a battery disposed within the vehicle; and
an electric motor configured to convert electrical energy stored in the battery into kinetic energy, wherein the vehicle is to be propelled by at least the electric motor, and wherein the first wind turbine is configured to convert energy from a relative wind into electrical energy that is to be stored in the battery.

2. The vehicular wind turbine system of claim 1, further comprising a wind detector configured to detect one or more properties of the relative wind.

3. The vehicular wind turbine system of claim 1, further comprising:
one or more additional wind turbines attached to the vehicle, wherein the one or more additional wind turbines are configured to convert energy from a relative wind into electrical energy that is to be stored in the battery via one or more additional electric generators coupled to the one or more additional wind turbines.

4. The vehicular wind turbine system of claim 1, wherein the first wind turbine comprises one or more vertical axis savonius wind turbine blades.

5. The vehicular wind turbine system of claim 1, wherein the first wind turbine is to activate responsive to a command of a vehicle operator, wherein the command comprises one or more of a vehicle braking command, a vehicle coasting command, or a vehicle parking command.

6. The vehicular wind turbine system of claim 5, further comprising:
a chamber disposed within a body of the vehicle, wherein the chamber houses the first wind turbine such that the first wind turbine does not project outside of the body, wherein the chamber comprises:
an inlet to receive incoming air from the relative wind;
an outlet to exhaust outgoing air from the first wind turbine;
an inlet shutter to regulate the incoming air; and
an outlet shutter to regulate the outgoing air;
wherein activation of the first wind turbine comprises opening the inlet shutter and the outlet shutter to expose the first wind turbine to the relative wind.

7. The vehicular wind turbine system of claim 6, further comprising an inlet channel and an outlet channel, wherein the inlet channel comprises an inlet flow path to direct incoming air from the inlet to the first wind turbine enclosed within the chamber, and wherein the outlet channel comprises an outlet flow path to direct outgoing air from the first wind turbine to the outlet.

8. The vehicular wind turbine system of claim 6, wherein the inlet is a variable inlet, and wherein a size of an opening of the inlet shutter is configured to adjust based on one or more properties of the relative wind.

9. The vehicular wind turbine system of claim 1, wherein the plurality of turbine blades have a variable geometry configured to optimize an efficiency of the first wind turbine based on the relative wind.

10. A method of operating a vehicular wind turbine system comprising:
receiving first data associated with an operator input of a vehicle;
determining a first action associated with a turbine of the vehicular wind turbine system based on the first data;
causing the first action to be performed; and
causing a battery of the vehicular wind turbine system to be charged responsive to the first action being performed.

11. The method of claim 10, wherein the first action comprises at least one of activating a turbine, adjusting a turbine inlet, adjusting a turbine shutter, or adjusting a turbine blade.

12. The method of claim 10, further comprising:
receiving an update of the first data;
determining a second action associated with the turbine based on the update of the first data;
causing the second action to be performed; and
causing charging of the battery to cease responsive to the second action being performed.

13. The method of claim 12, wherein the second action comprises at least one of deactivating a turbine, adjusting a turbine shutter, or adjusting a turbine blade.

14. The method of claim 10, wherein the first data comprises a braking notification.

15. The method of claim 10, wherein the first data comprises a notification of at least one of a velocity or an acceleration.

16. The method of claim 10, further comprising:
receiving second data that indicates a relative wind from a wind detection sensor; and
determining a third action associated with the wind turbine system based on the second data; and
causing the third action to be performed.

17. The method of claim 16, wherein the third action comprises at least one of adjusting a turbine inlet, adjusting a turbine shutter, or adjusting a turbine blade.

18. The method of claim 10, further comprising:
receiving second data that indicates a relative wind from a wind detection sensor, wherein the first action is determined based on the first data and the second data.
